(19) United States
(12) Patent Application Publication
(10) Pub. No.: US 2009/0014363 A1
(43) Pub. Date: Jan. 15, 2009

(54) DROP-OFF RECYCLING SYSTEM AND METHOD THEREOF

(75) Inventors: RON GONEN, New York, NY (US); Frank C. Yang, Framingham, MA (US); Bridget Croke, Duxburry, VT (US); Scott Lamb, Berwyn, PA (US)

Correspondence Address: MALDJIAN & FALLON LLC, 365 BROAD ST. , 3RD FLOOR, RED BANK, NJ, 07701, US

(73) Assignee: RecycleBank LLC, Philadelphia, PA (US)

(21) Appl. No.: 12/189,218

(22) Filed: Aug. 11, 2008

Related U.S. Application Data
(63) Continuation-in-part of application No. 11/345,867, filed on Feb. 2, 2006.
(60) Provisional application No. 60/954,857, filed on Aug. 9, 2007.
(60) Provisional application No. 60/650,610, filed on Feb. 7, 2005.

(51) Int. Cl. B07C 5/34; G05B 19/42

(52) U.S. Cl. 209/559; 700/89

(57) ABSTRACT

Embodiments of the present invention relate to a system and method of providing incentive to recycle recyclable materials by providing financial incentives to consumers for recycling at a central drop-off recycling facility. In one embodiment of the present invention, a method of providing incentive to recycle recyclable materials comprises creating an account for at least a first entity, providing a drop-off recycling center for receiving a plurality of recyclable materials from at least the first entity, receiving the recyclable materials at the drop-off center for processing, measuring and recording quantitative or qualitative data for the recyclable materials, calculating a reward correlating to the quantitative or qualitative data recorded for the recyclable materials and crediting the account for the first entity with the reward.

### CROSS-REFERENCE TO RELATED APPLICATIONS

This application is a continuation-in-part of U.S. patent application Ser. No. 11/345,867, filed on Feb. 2, 2006, which claims the benefit of U.S. Provisional Patent Application Ser. No. 60/650,610, filed on Feb. 7, 2005, the disclosures of which are incorporated herein by reference in their entireties. This application also claims the benefit of U.S. Provisional Patent Application Ser. No. 60/954,857, filed on Aug. 9, 2007, the disclosure of which is also incorporated herein by reference in its entirety.

### BACKGROUND OF THE INVENTION

1. Field of the Invention

Embodiments of the present invention generally relate to a drop-off recycling system and method thereof. More specifically, embodiments of the present invention relate to a system and method of providing incentive to recycle recyclable materials by providing financial incentives to consumers for recycling at a central drop-off recycling facility.

2. Description of the Related Art

Over the past few decades, costs for collecting and disposing waste material (“waste”) have skyrocketed. Decreases in available landfill capacity have caused the cost associated with disposing of waste in such landfills to increase. Adding to these costs are governmental (e.g., federal, state and local) landfill taxes, which have also increased sharply over the past few decades.

Even where landfill capacity exists, the cost associated with potential and actual environmental hazards associated with landfill operation are likewise increasing. These costs can include, for example, losses of valuable property and environmental cleanup costs for rehabilitating landfills and surrounding areas that become contaminated with dangerous chemicals due to the disposal and decomposition of the waste. Given the financial and environmental burdens associated with the collection and disposal of waste, municipalities have actively pursued recycling as an alternative to disposal.

Fortunately, demand for recyclable material has increased as a result of expansion in manufacturing. Manufacturers have long recognized that manufacturing goods from recyclable material less costly than manufacturing such goods from virgin material due to, for example, the costs associated with extracting and processing the virgin material into useable form.

Advances in Single Stream Recycling (SSR) technology reduce the cost of recycling. In addition, recent improvements in automated separation of commingled recyclable material at processing centers have dramatically reduced the cost of collecting, sorting, and processing the recyclable material. The combination of the SSR technology and automated separation enables an automated process to separate and process commingled recyclable material (for example, cardboard, paper, plastic, glass metals, organics, or any reusable material, not desirable for landfills). This combination enables and permits processing centers to cut costs (e.g., reduce labor costs and sorting time) by using an automated process to separate the recyclables as opposed to manual labor. In addition, the combination enables municipalities to cut cost of collection by collecting the recyclable material in commingled form.

While information-technology tools have revolutionized the way many governments and industries operate, the waste management industry has not embraced information technology in the same way. As such, the waste management industry lacks modern, up-to-date information technology tools for efficiently carrying out business management, operations management and other activities associated with recycling (collectively “recycling activities”). In turn, this lack of information-technology tools has limited municipalities and/or other entities administering recycling programs to provide incentives for entities, such as business, governments and households, to recycle; to design effective strategies for recycling; to measure performance against such recycling strategies; etc.

Recycling reduces the financial and environmental burdens of waste disposal, reduces energy costs, and conserves our environments resources. There is, therefore, a need to establish recycling initiatives which recognize the existing problems associated with the disposal of waste and promote recycling efforts as part of a waste management program.

### SUMMARY OF THE INVENTION

Embodiments of the present invention relate to a system and method of providing incentive to recycle recyclable materials by providing financial incentives to consumers for recycling at a central drop-off recycling facility. In one embodiment of the present invention, a method of providing incentive to recycle recyclable materials comprises creating an account for at least a first entity, providing a drop-off recycling center for receiving a plurality of recyclable materials from at least the first entity, receiving the recyclable materials at the drop-off center for processing, measuring and recording quantitative or qualitative data for the recyclable materials, calculating a reward correlating to the quantitative or qualitative data recorded for the recyclable materials and crediting the account for the first entity with the reward.

In another embodiment of the present invention, a method of recycling recyclable materials comprises supplying a recyclable container to and creating an account for at least a first entity, providing a drop-off recycling center for receiving a plurality of recyclable materials from at least the first entity, receiving the recycling container having recyclable materials therein at the drop-off center, scanning unique identification data from the recycling container, validating the unique identification data received from the recycling container, measuring and recording quantitative or qualitative data for the recyclable materials in the recycling container, calculating a reward correlating to the quantitative or qualitative data recorded for the recyclable materials, uploading unique identification data and the reward to a central database, and crediting the account for the first entity with the reward.

In yet another embodiment of the present invention, a system for providing incentive to recycle recyclable materials comprises a drop-off center for receiving recyclable materials for processing, a load determining device for determining a quantifiable measurement of the recyclable materials, an account management system, and a reward calculating device for determining a reward value correlating to the quantifiable measurement of the recyclable materials, wherein the reward value is communicated to the account management system via a computer network.

### BRIEF DESCRIPTIONS OF THE DRAWINGS

So the manner in which the above recited features of the present invention can be understood in detail, a more detailed description of embodiments of the present invention is described below with references to the Figures illustrated in the appended drawings. The figures in the appended drawings, like the detailed description, illustrate only examples of embodiments. As such, the Figures and the detailed description are not to be considered limiting, and other equally effective examples are possible and likely, wherein:

FIG. 1 depicts a block diagram of a system in accordance with one embodiment of the present invention;

FIG. 2 depicts a schematic representation of a data-acquisition unit and a server in accordance with one embodiment of the present invention; and

FIG. 3 depicts a flow chart of a method of managing recyclable materials in accordance with one embodiment of the present invention.

As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention relate to a drop-off system for recycling by providing financial incentives to consumers for recycling at a central drop-off recycling facility. As used herein, the term “recyclable materials” refers to any material, which can be processed or otherwise altered in order to recover used or deteriorated material. “Recyclable materials” may include, but is not limited to, plastics, metals, electronics, and any other suitable material in accordance with embodiments of the present invention. Additionally, as used herein, the term “reward” refers to either monetary rewards or rewards based upon a points system, wherein points are redeemable for gift certificates or other goods/services.

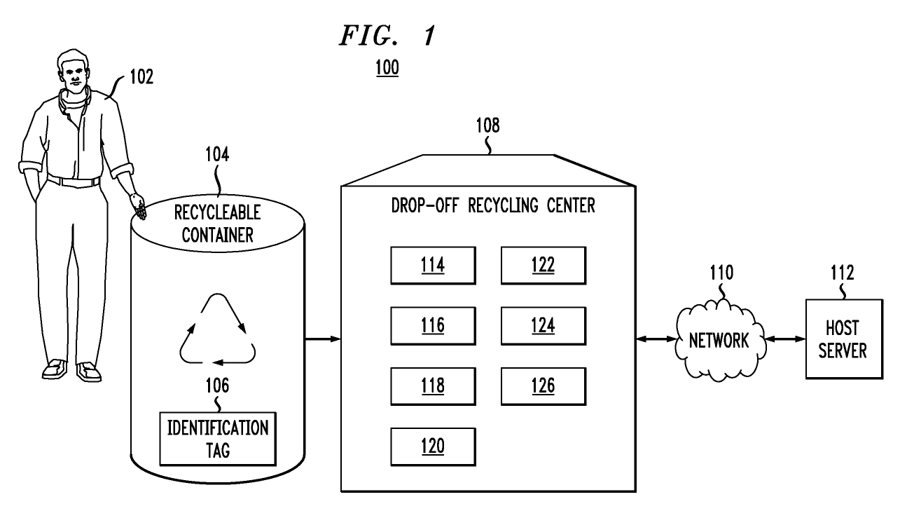

FIG. 1 is a block diagram illustrating an example of a system 100 of recycling recyclable material at a drop-off recycling facility. Generally, the system 100 includes a recycling container 104, a drop-off center 108, network 110, and a host server 112.

The recycling container 104 may comprise any suitable container for transporting recyclable materials to a drop-off center 108. The recycling container 104 may be of any shape or size so long as it is adapted to hold a quantifiable measure of recyclable material. The recycling container 104 may be provided to an entity 102 for a fee (e.g., a one-time, fixed, rental, deposit, or other type of fee) or at no cost (e.g., on loan or given outright to the entity 102), at the time, for example, when the entity 102 registers with the drop-off center 108 to utilize the recycling services.

The recycling container 104 may be identifiable with an entity 102 by an identification tag 106 having a unique identifier (e.g., an alphanumeric code representative of a single entity). In one embodiment, the identification tag 106 may be placed on an outer surface of the recycling container 104. In alternative embodiments, the identification tag 106 may be a card, keyfob, identification means, or the like, held by a person responsible for delivering the recyclable materials to the drop-off center 108.

The identification tag 106 may be used by an attendant 114 at the drop off center 108 to identify the entity 102 associated with the container 104 via the unique identifier. The identification tag 106 may be machine-readable device, such as a bar-code label, a magnetic-strip device, a radio-frequency-identification (“RFID”) tag and the like; and may include and/or be programmed with information for identifying the recycling container 104, and in turn, information (e.g., an address, an account, etc.) associated with the entity (“entity information”).

Alternatively, the identification tag 106 may be a non-machine readable label or other non-machine readable device. As such, the identification tag 106 may include an identifier that can be transferred to (e.g., manually entered into) the host server 112, which in turn, uses the unique identifier to obtain information stored thereon for identifying the recycling container 104 and the entity information.

In accordance with embodiments of the present invention, the drop-off center 108 may be any location where a town, city, municipality, organization, or the like, collects recycled materials. In one embodiment, the facility may be a gated property, operated by a municipality, and open during predetermined hours. The drop-off 108 center may include one or a plurality of storage bins 114, a load-determining device 116, a data acquisition unit 118, a deciphering device 120, a transportation vehicle 122, an attendant 124, and a fraud detection system 126.

In one embodiment, the storage bins 114 may be of any size or shape so long as they are adapted to hold the recyclable materials deposited by the entity after it has been measured and recorded. In one embodiment of the present invention, a plurality of storage bins may be used with each bin corresponding to one class of recyclable materials (e.g., paper, plastics, metals, glass, etc.) in which materials of that class may be deposited. In another embodiment of the present invention, a single large storage bin may be used for depositing all recyclable materials regardless of class.

The load-determining device 116 may include any of, any multiple of, any combination of or any combination of multiples of a scale, load cell, load-cell system, a counting device and/or system or other measuring apparatus or system for (i) determining a quantifiable measure (e.g., weight, quantity, etc.) of the deposited recyclable materials and/or (ii) transferring such quantifiable measure (“deposited-material measure”) to the data-acquisition unit 118 for storage and/or subsequent processing. The load-determining device 116 may, for example, determine the deposited recyclable material measure as a function of a plurality of weight measurements of the recycling container obtained before and after the deposited material are transferred to the storage bin. In alternative embodiments, the load-determining device 116 may also determine a qualitative measurement of the recyclable materials (e.g., a volume, quality, etc.).

The drop-off center may include an attendant 124, who may be a person or a plurality of persons present at the facility during a predetermined time period. At the drop-off center, an attendant 124 may use a deciphering device 120 adapted to obtain the unique identifier from the identification tag 106 corresponding to an entity 102. The deciphering device 120 may be operable to communicate with the data-acquisition unit 118 to allow for verification of the unique identifier. In one embodiment, the deciphering device 120 may be a handheld barcode reader to obtain a unique identifier from a bar-coded keycard held by the entity. In another embodiment, the deciphering device 120 may be an RFID reader to obtain the unique identifier from an RFID tag embedded in the entity's recycling container 104. In other embodiments, other deciphering devices capable of obtaining and transmitting data to ascertain an identity, and the like, may also be used.

In one embodiment of present invention, the drop-off center 108 may include a fraud detection system 126. The fraud detection system 126 may comprise a video surveillance system. The video surveillance system may be installed and configured such that the attendant 124 may have the capability to monitor the area within and outside the drop-off center 108 to detect fraudulent activities. Such fraud detection system 126 may provide additional security, for example, where a single attendant 124 must monitor the recycling activities of a significant number of entities delivering recyclable materials to the drop off center at one time.

In accordance with an embodiment of the present invention, the transportation vehicle 122 may include a truck or other movable vehicle adapted to transport the recyclable materials from the drop-off center 108 to an industrial/commercial recycling facility.

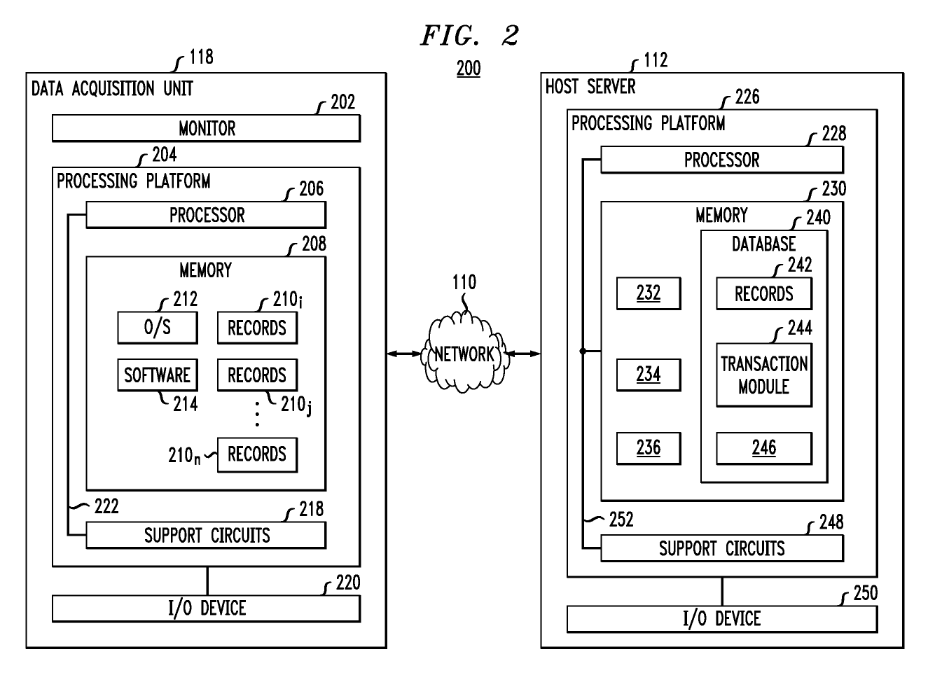

FIG. 2 depicts a schematic representation of a data-acquisition unit and a server in accordance with one embodiment of the present invention. The data-acquisition unit 118 at the drop-off center 108 and host server 112 may be communicatively coupled together via a link or network 110 (collectively “network”). In such an embodiment, the data-acquisition unit 118 and host server 112 may exchange information via one or more communications carried over the network 110.

The data-acquisition unit 118 may be, for example, any of or any combination of a personal computer; a portable computer, a handheld computer; a mobile phone, a digital assistant, a personal digital assistant, a cellular phone, a smart phone, a digital tablet, a laptop computer, an Internet appliance and the like. In general, the data acquisition unit 118 includes a processor-based platform 204 that operates on any suitable operating system, such as OS/2, Java Virtual Machine, Linux, Solaris, UNIX, HPUX, AIX, Windows, MacOS, and the like; and that is capable of executing software.

Additionally, the data acquisition unit 118 may be formed in a single unitary device and concentrated on a single server, client, peer or other type node. Alternatively, the data acquisition unit 118 may be formed from one or more separate devices, and as such, may be distributed among a number of server, client, peer or other type nodes.

The data acquisition unit 118 may include a large number of elements; most of which are not shown in FIG. 2 for simplicity of exposition. As shown, the data acquisition unit 118 includes a processing platform that is operable to control, manipulate or otherwise interact with a monitor or other display device (collectively “monitor”) and/or an input/output (“I/O”) device, via respective couplings.

The monitor 202 may be any suitable device that displays viewable images and/or text generated by the processing platform 204. For instance, the monitor 202 may be any of or any combination of a liquid-crystal-display based monitor, a cathode ray tube monitor, a plasma display monitor, a surface-conduction electron-emitter display monitor, an organic light-emitting diode display monitor, or any other monitor that can display viewable images using television and/or computer protocols, such as Super Video Graphics Array, Digital Visual Interface, Phase Alternating Line, SECAM, NTSC, etc.

The I/O device 220 may be any device that accepts input from a user (person or machine) to control, manipulate or otherwise interact with the operation of the processing platform 204. In addition, the I/O device 220 may be adapted to obtain from the identification tag 106 the entity information and/or identifier that identifies the recycling container 104. Examples of the I/O device 220 include any of or any combination of pointing device, such as a mouse, joystick, trackball, touchpad, pointing stick, light pen, head pointer, soap mouse, eye tracking devices, digitizing tablet and stylus, data glove that translates the user's movements to computer gestures; and a key-in device, such as a keyboard or a touchpad; a reader, such as a bar-code reader, a magnetic-strip reader, a RFID reader, and the like. In addition, the I/O device 220 and the monitor 202 may be integrated or otherwise combined together in a single device and/or housing.

The processing platform 204 includes memory 208, one or more processors (collectively “processor”) 206, supports circuits 218 and bus 222. The memory 208 may employ random access memory, read-only memory, optical storage, magnetic storage, removable storage, erasable programmable read only memory and variations thereof, content addressable memory and variations thereof, flash memory, disk drive storage, removable storage, any combination thereof, and the like.

The memory 208 may store and/or receive requests from the processor 206 to execute various software packages such as operating system 212. Additionally, the memory 124 may store and/or receive requests from the processor 206 to obtain (i) operands, operators, dimensional values, configurations, and other data that are used by the operating system 212 and the software 214 to control the operation of and/or to facilitate performing the functions of the data acquisition unit 118; and/or (ii) one or more records or other data structures (collectively, “records”) 210.sub.i-210.sub.n.

Each of the records may be stored as or in a single file or a plurality of files, and may be structured as text, a table, a database, a distributed hashtable, a distributed concurrent object store, a document formed using a markup or markup-like language, and the like. The records may include, for example, a deposited-material record 210.sub.j. The deposited-material record 210.sub.j may store, be populated with or otherwise adapted to hold the deposited-material measure as determined by the load-determining device.

The processor 206 may execute (e.g., launch, generate, run, maintain, etc.) and/or operate on the operating system. The processor 206 may be capable of (i) executing the software 214; (ii) storing the records 210.sub.i-210.sub.n in the memory 208; (iii) dispatching to the host server 112 the records 210.sub.i-210.sub.n (including the deposited-material record 210.sub.j) for further processing; (iv) issuing triggers and/or (v) issuing one or more commands and/or instructions to cause the further processing of records 210.sub.i-210.sub.n. Examples of the processor 206 include conventional processors, microprocessors, multi-core processors, microcontrollers and the like.

The support circuits 218 facilitate operation of the processor 206 and may include well-known circuitry or circuits, including, for example, an I/O interface; one or more network-interface units (“NIUs”); cache; clock circuits; power supplies; and the like. The NIUs may be adapted for communicating over any of, any multiple of, any combination of or any combination of multiples of terrestrial wireless, satellite, and/or wireline media. The processor 206 (and in turn, the data-acquisition unit 118) may use the NIUs for exchanging content with the host server 112 via network 110.

The bus 222 provides for transmissions of digital information among the processor 206, the memory 208, support circuits 218 and other portions of the data acquisition unit 118 (shown and not shown).

The operating system 212 may include code for operating the data acquisition unit 118 and for providing a platform onto which the software 214 can be executed. The software 214 may include data-acquisition software, which may carry out the acquisition of and storage of the deposited-material measure into the deposited-material record 210.sub.j.

The data-acquisition software may also communicate the deposited-material record 210.sub.j to the host server 112 using, for example, the communication and/or security protocols compatible with the data acquisition unit 118 and the host server 112. To facilitate this, the data-acquisition software may include code to allow the data-acquisition software (and/or the data acquisition unit 118) to substantiate its identity, and in turn, receive authorization to access (e.g., view, configure, use and/or execute) services of the host server.

The network 110 may be a partial or full deployment of most any communication or computer network or link, including any of, any multiple of, any combination of or any combination of multiples of a public or private, terrestrial wireless or satellite, and wireline networks or links. The network 110 may include, for example, network elements from the Internet, core and proprietary public networks, wireless voice and packet-data networks, such as 1 G, 2 G, 2.5 G and 3 G telecommunication networks, wireless local area networks (“WLANs”), including, Bluetooth and/or IEEE 802.11 WLANs, wireless personal area networks (“WPANs”), wireless metropolitan area networks (“WMANs”) and the like; and/or communication links, such as Universal Serial Bus (“USB”) links; parallel port links, Firewire links, RS-232 links, RS-485 links, and the like.

The network elements and/or communication links may include circuit-switched as well as packet-data elements to provide transport of content, triggers and/or other information; and may be configured to communicate such information using any number of protocols and in any manner consistent with exchanging information. These protocols may include standardized, open-source, and freely-available communication protocols for communicating content in circuit-switching and/or packet data networks, and the like.

The host server 112 may be any type of server suitable for embodiments of the present invention. The host server 112 may be deployed in one or more general or specialty purpose computers, personal computers, mainframes, minicomputers, server-type computers and/or any a processor-based platform that operates on any suitable operating system, such as Windows and/or Linux; and that is capable of executing software.

The host server 112 may include a large number of elements; most of which are not shown in FIG. 2 for simplicity of description. The elements of host server 112 may be formed in a single unitary device and concentrated on a single server, client, peer or other type of node. Alternatively, the elements of host server 112 may be formed from two or more separate devices, and as such, may be distributed among a number of server, client, peer or other type nodes.

As shown, the host server 112 includes a processing platform 226 that is operable to control, manipulate or otherwise an input/output (I/O) device, one or more processing units (collectively “processor”) 228, supports circuits 248, BUS 252 and memory 230.

The I/O device 250 may be any device that accepts input from a user to control, manipulate or otherwise interact with the operation of the processing platform 226. Examples of I/O devices may include any or any combination of (i) storage devices, including but not limited to, a tape drive, a floppy drive, a hard disk drive or a compact disk drive, (ii) a receiver, (ii) a transmitter, (iii) a speaker, (iv) a display, (v) a speech synthesizer, (vi) an output port, (vii) a pointing device, such as a mouse, joystick, trackball, touchpad, pointing stick, light pen, head pointer, soap mouse, eye tracking devices, digitizing tablet and stylus, data glove that translates the user's movements to computer gestures, (viii) a key-in device, such as a keyboard or a touchpad, (ix) and the like.

The processor 228 may be one or more conventional processors, microprocessors, multi-core processors, microcontrollers and the like. The processor 228 may execute (e.g. launch, generate, manipulate, maintain, etc.) and/or operate on the operating system 232.

The support circuits 248 facilitate operation of the processor 228, and may include well-known circuitry or circuits, including, for example, one or more I/O interfaces; one or more network interface units (“NIUs”); cache; clock circuits; data registers; power supplies and the like. The NIUs facilitate exchange (e.g., sending and/or receiving) of content. Accordingly, the NIUs may be adapted for communicating over any of, any multiple of, any combination of or any combination of multiples of terrestrial wireless, satellite, and/or wireline media. The processor 228 may use the NIUs for exchanging content with the host server 112 via network 110.

The bus 252 provides for transmissions of digital information among the processor 228, memory 230, support circuits 248 and other portions of the host server 112, not shown in the Figure.

The memory 230 may store processor-executable instructions and data that may be executed by and used by the processor 228. The processor-executable instructions may include hardware, firmware, software, and the like or any combination thereof. The memory 230 may be or employ random access memory, read-only memory, optical storage, magnetic storage, removable storage, erasable programmable read only memory and variations thereof, content addressable memory and variations thereof, flash memory, disk drive storage, removable storage, any combination thereof, and the like.

The memory 230 may store and/or receive requests from the processor 228 to execute various software packages, such as operating system 232, application-server software 234, database software 236 and a database 240.

The operating system 232 is the software component of computer system that is operable to serve as a bridge between the computer hardware and application software with which the computer works. The operating system 232 acts as a host for application programs that are run on the host server 112. Some examples of various operating systems include OS/2, Java Virtual Machine, Linux, Solaris, UNIX, HPUX, AIX, Windows, MacOS, and the like.

The application-server software 234, when executed by the processor 228, is operable to communicate with the data-acquisition unit 118, via the network 110, to obtain the recyclable materials data and calculate a reward for the recyclable materials. In addition, the application-server software 234, when executed by the processor 228, is operable to allocate the reward to the entity 102 and credit the reward to the entity's account.

The database 240 may include a number of records 242 into which the entity's data, the deposited materials data and/or other information may be parsed and stored. The database software 236 may include and/or employ one or more database management systems (“DBMS”), such as any of an Oracle, DB2, Microsoft Access, Microsoft SQL Server, Postgres, MySQL, 4th Dimension, FileMaker and Alpha Five DBMS, and the like. The DBMS may be operable to query the database 240, parse the information into the records 242, execute rules for sorting the information parsed into the records 242, execute rules for performing operations (e.g., mathematical, statistical, logical, etc., operations) on the information parsed into the records 242, and the like. The database software 236 may include a number of software modules that are called by the database software 236 for execution by the processor 228. These software modules include a transaction module 244 and a reward allocation module 246.

The transaction analysis module 244, when executed by the processor 228, may be operable to analyze the activities of one or more entities at the drop-off center. The reward allocation module 246, when executed by the processor 228, may be operable to determine that the proper rewards are being credited to the proper entity accounts.

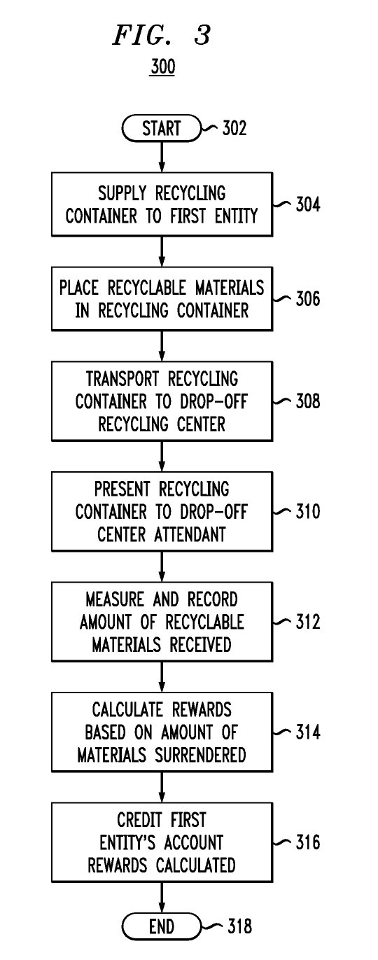

FIG. 3 depicts a flow chart of a method for recycling recyclable materials in accordance with one embodiment of the present invention. For convenience, method 300 is described in reference to the system 100 of FIG. 1. It is contemplated however, the method 300 may also be carried out within other system architectures as well.

The method 300 begins at step 302. At step 304, the entity is supplied a recycling container 104 if or when he or she registers for recycling service. In one embodiment of the present invention, the recycling container is identifiable with one particular entity via an identification tag 106 on the container. The entity 102 may pick up his or her recycling container 104 at the drop-off center or it may be delivered to their respective homes. During registration for recycling services, the entity may be issued a unique identifier which may embedded within a bar code, RFID tag, or the like. This unique identifier may contain a unique identification number corresponding to the entity. The ways in which an entity obtains a recycling container 104 are not limited to those mentioned herein.

At step 306, entity 102 places recyclable materials in the recycling container 104. The recyclable material may be one type of or any combination of types of recyclable material, including, for example, cardboard, paper, plastic, glass and/or aluminum material.

At step 308, the entity 102 transports the recycling container to the drop-off center 108. For example, the entity may transport the recycling container 104 to the center via a car, truck, SUV, or the like.

At step 310, the entity presents the recycling container 104 with recyclable materials therein to the drop-off center attendant 124. During this step, the attendant 124 scans the identification tag 106 on the recycling container 104 with a deciphering device 120 which he or she possesses. Once the identification tag 106 is scanned by the deciphering device 120, the information received may be optionally verified against the entity data in database 240 corresponding to the entity.

At step 312, the quantity of recyclable materials received is measured and recorded by the load-determining device 116. Examples of quantifiable measure include. but are not limited to, the weight of the amount of recyclable materials, the volume of the recyclable materials obtained by estimation or approximation using visual indication (i.e., half-full, quarter-full, etc.), or the like. The load-determining device 116 then transfers this measurable data to the data-acquisition unit 118 for storing and processing of future transactions. The data-acquisition unit 118 may upload this information to the host server 112. The quantifiable measurement data may also be recorded by the attendant 124 physically, electronically, or the like.

At step 314, a reward amount is calculated for the recyclable materials received by the entity 102. Prior to step 314, the entity may deposit the recyclable materials in one or more storage bins 114. The entity 102 may deposit the recyclable materials in individual storage bins corresponding to a class of materials (i.e. paper, plastics, metals, etc.). Alternatively, the entity 102 may deposit all recyclable materials in one large storage bin irrespective of the class of materials.

At some point after the recyclable materials have been measured and recorded, the quantitative measure received for the recyclable materials may be uploaded and stored in database 240. This data for the recyclable materials received may be used in the database 240 and along with database software 236 to calculate the reward amount the entity will receive. An algorithm, mathematical function or the like may be used as a way of generating this reward amount. Once the amount is calculated, it is subsequently recorded.

In a first exemplary embodiment, the reward amount may be assigned directly correlating to the amount a participant recycled for each instance they deposit recyclable materials at the drop-off center (e.g., one reward for one unit of weight of recyclable materials). Other exemplary embodiments contemplate the above, as well as similar predetermined algorithms. The database software 236 in combination with the database 240 and algorithms may provide flexibility in applying different rates for determining the value. These rates may differ based on availability of the financial offerings, the type of entity, geographic area of the entity, and other demographics. Generally, the rates may be applied to ascertain an optimum incentive for recycling the recyclable materials.

At step 316, the reward amount calculated from step 314 may be credited to the entity's account. Optionally, verification of the entity's account information may be performed to ensure that a correct credit is made to the proper entity. The reward calculated is credited to the entity 102 via database software 236 and the database 240. This reward information may be placed in records 242 and linked with entity's account information data.

At step 318, the method 300 ends. However, the method 300 may be repeated for a multitude of entities, periodically or as many times as entities can enter the drop-off center location.

While the foregoing is directed to embodiments of the present invention, other and further embodiments of the invention may be devised without departing from the basic scope thereof.

What is claimed is:

1. A method of providing incentive to recycle recyclable materials comprising:
creating an account for at least a first entity;
providing a drop-off recycling center for receiving a plurality of recyclable materials from at least the first entity;
receiving the recyclable materials at the drop-off center for processing;
measuring and recording quantitative or qualitative data for the recyclable materials;
calculating a reward correlating to the quantitative or qualitative data recorded for the recyclable materials; and
crediting the account for the first entity with the reward.

2. The method of claim 1, wherein receiving the recyclable materials further comprises obtaining unique identification data from the first entity.

3. The method of claim 2, wherein the unique identification data is embedded within a bar code or RFID tag.

4. The method of claim 1, wherein measuring and recording quantitative or qualitative data for the recyclable materials is conducted by a load determining device.

5. The method of claim 2 further comprising:
uploading unique identification data to a central database.

6. A method of recycling recyclable materials comprising:
supplying a recyclable container to and creating an account for at least a first entity;
providing a drop-off recycling center for receiving a plurality of recyclable materials from at least the first entity;
receiving the recycling container having recyclable materials therein at the drop-off center;
scanning unique identification data from the recycling container;
validating the unique identification data received from the recycling container;
measuring and recording quantitative or qualitative data for the recyclable materials in the recycling container;
calculating a reward correlating to the quantitative or qualitative data recorded for the recyclable materials;
uploading unique identification data and the reward to a central database; and
crediting the account for the first entity with the reward.

7. The method of claim 6, wherein scanning unique identification data from the recycling container comprises utilizing a deciphering device.

8. The method of claim 6, wherein the quantitative or qualitative data for the recyclable materials in the recycling container comprises at least one of the weight of the recyclable materials or the volume of the recyclable materials.

9. The method of claim 6, wherein the step of calculating a reward correlating to the quantitative or qualitative data recorded for the recyclable materials comprises applying the quantifiable measure data to a predetermined algorithm directly correlating to a value of the quantitative or qualitative data.

10. A system for providing incentive to recycle recyclable materials comprising:
a drop-off center for receiving recyclable materials for processing;
a load determining device for determining a quantifiable measurement of the recyclable materials;
an account management system; and
a reward calculating device for determining a reward value correlating to the quantifiable measurement of the recyclable materials;
wherein the reward value is communicated to the account management system via a computer network.

11. The system of claim 10, wherein the account management system comprises a database for storing a plurality of information relating to individual accounts.

12. The system of claim 10, further comprising a device for obtaining identification of an entity associated with the recyclable materials.

13. The system of claim 12, wherein the device for obtaining identification comprises one of a barcode reader or a RFID reader.

14. The system of claim 10, wherein the load determining device comprises a weight measuring means.

15. The system of claim 10, wherein the drop-off center further comprises at least a storage container for storing received recyclable materials.

16. The system of claim 10, further comprising a fraud detection system configured to monitor activities within the drop-off center.

17. The system of claim 16, wherein the fraud detection system comprises video surveillance equipment.

18. The system of claim 10, wherein quantifiable measurement of the recyclable materials comprises at least one of the weight of the recyclable materials or the volume of the recyclable materials in a recycling container.

19. The system of claim 10, wherein determining a reward value correlating to the quantifiable measurement of the recyclable materials comprises applying the quantifiable measurement of the recyclable materials to a predetermined algorithm, directly correlating to the value of the quantifiable measurement.

20. The system of claim 10, wherein the account management system is hosted on a remote server.
